(19) United States
(12) Patent Application Publication
(10) Pub. No.: US 2009/0095868 A1
(43) Pub. Date: Apr. 16, 2009

(54) SUPPORTING ARRANGEMENT FOR A PRESENTATION DEVICE

(75) Inventor: Carl-Eric OHLSON, Stockholm (SE)

Correspondence Address: THE MAXHAM FIRM, 9330 SCRANTON ROAD, SUITE 350, SAN DIEGO, CA, 92121, US

(73) Assignee: AO MEDICAL PRODUCTS SWEDEN AKTIBOLAG, Kista (SE)

(21) Appl. No.: 12/265,547

(22) Filed: Nov. 5, 2008

Related U.S. Application Data
(63) Continuation-in-part of application No. 10/544,299, filed on Aug. 3, 2005, now abandoned.

(30) Foreign Application Priority Data
Feb. 6, 2003 (SE) 0300306-8
Feb. 5, 2004 (SE) PCT/SE2004/000047

(51) Int. Cl. F16M 11/12

(52) U.S. Cl. 248/371

(57) ABSTRACT

An arrangement for supporting a presentation device, for example in the form of an image presentation screen, wherein a work surface is connected to the supporting arrangement, wherein the supporting arrangement and the work surface are both vertically and transversely movable and pivotally disposed, and wherein the pivotal movement of the work surface is forcibly coupled to the angular movement of the supporting arrangement such as to achieve simultaneously a change in the angle of the supporting arrangement in relating to a stand on the one hand, and a change in the angle of the work surface in relation to the stand on the other hand, in response to the influence exerted by a maneuvering device.

### FIELD OF THE INVENTION

The present invention relates to the field of ergonomics at a working place, such as for computerized work, and particularly relates to image screen work.

### BACKGROUND OF THE INVENTION

The use of working stations for computerized terminal work varies from simple routines to a more complicated medicinal use.

The diagnostic examination of the images of patients obtained by x-ray investigations, magnetic resonance imaging, and ultrasound investigations, for example, require significant concentration and is more or less stressful, depending on prevailing circumstances with regard to light functions and also to the ergonomic strain to which the viewer is subjected.

The examination of analog images in so-called light cabinets is either adapted for a seated or for standing working posture but, seen totally, is encumbered with serious ergonomic deficiencies with respect to both visual ergonomics and viewer-afflicting ergonomics.

However, the examination of digital images at computerized working stations affords many technical and ergonomic benefits that facilitate image handling processes, analyses, and diagnoses in comparison with analog techniques. Unfortunately, the remainder of the equipment, so-called terminal work stations, are not adapted to suit the desiderata and requirements of vision ergonomics and viewer-afflicting ergonomics.

It is generally known that a change in working posture will relieve the load on the spine and on the extremities of the person concerned, in addition to being restful. For example, the transition from an upright sitting posture to a rearwardly inclined sitting posture results in a significant change in the position of the person and also in his or her positional relationship with the image presentation device. In respect of an upright sitting posture, the head of the viewer should be inclined slightly forwardly and with his/her eyes directed downwardly, so as to facilitate the function of the eyes' tear ducts, among other things. The transition to a rearwardly inclined seated working posture makes viewing of the presentation screen difficult to achieve, because the screen is too far away, wrongly angled, and does not permit perpendicular focusing, and because the viewer is too low and is necessitated to bend his/her head forward. This is particularly problematic for users that wear progressive spectacles, whose optical properties mean that the lower field of vision is adapted to a focal distance that deviates in relation to the image presentation screen. This drawback constitutes a serious vision ergonomic and tiring disadvantages, partly as a result of a wrong working posture, which sooner or later results in strain-induced injuries.

It is impractical to adjust every image presentation screen when changing a working posture, both from an ergonomical aspect and from a time-consuming aspect.

The need to adjust the angle of the equipment to varying extents in order to suit the differences in body structure of individual users is also found in a standing working posture. A typical example in this regard is found in old-fashioned writing desks which, in practical use, resulted in a tabletop that was angled to the vertical plane to a greater or lesser extent.

U.S. Pat. No. 5,339,750 teaches an adjustable workable that includes two individually raisable and lowerable work surfaces where the angular position of each work surface can also be adjusted individually. It is also disclosed in this patent that a convenient field of use is computer usage, where one work surface is used to support a computer screen and one work surface is used to support a keyboard, for example

Available workstations, for instance, workstations operating in accordance with the principle described in the aforesaid patent, are generally equipped for motorized vertical height adjustment for limited adaptation of the position of the tabletop and image presentation screens in relation to different users.

The ergonomical deficiencies of computerized workstations can be summarised as follows: the distance of the user's eyes from the screen concerned is varied considerably both horizontally and vertically in the transition between an upright sitting position and a rearwardly inclined position, and also in combination with a standing working posture. The tabletop cannot be adapted with regard to a standing posture. Moreover, maneuvering of the different tabletops in achieving such adjustments cannot be effected quickly and simply.

### SUMMARY OF THE INVENTION

The present invention eliminates the aforesaid drawbacks by minimizing deviations in the distance of the user's eyes to the image presentation screen both horizontally and vertically in a transition between an upright sitting posture and a rearwardly inclined posture.

In addition, there is achieved a continuous optimized working posture in relation to the presentation device and the work surface despite changes between an upright sitting posture and a rearwardly inclined posture through the medium of only one single maneuvering device, thereby enabling the vertical position and the inclination of a presentation device and a work surface to be adjusted quickly and simply.

The maneuvering device also enables the tabletop to be angled in the horizontal plane to suit a standing working posture without altering the distance of the user's eyes from the presentation screen concerned.

As illustrated in the following exemplifying embodiments, the invention relates to a supporting arrangement in an image screen working station, including coordinated multifunctional motorized or mechanical counterbalanced movement of the tabletop and the image presentation screen relative to the different sitting and standing working postures of the user. A station for image screen work including coordinated multifunctional motorized or mechanical counterbalanced movement for the user's work surface and image screen supporting device relative to the different sitting and standing working postures of the user is effective in optimizing the eye distance and position of the user in relation to an image presentation screen. Several image presentation screens may be handled simultaneously.

The relationship between the user's work surface and the image screen supporting arrangement can be controlled mechanically, wherein the design of the supporting device can be adapted to a desired change in the relative position between the surface and the supporting arrangement, for instance, by providing the stand with a guide groove as in the case of an illustrated exemplifying embodiment. The relationship between the user's work surface and the image screen supporting arrangement may be controlled mechanically, wherein the design of the supporting arrangement can be adapted to a desired change in position between the surface and the supporting arrangement, either by replacing appropriate parts of the arrangement or by providing the arrangement with adjustable functions.

The invention also provides a limitation and adaptation of the multifunctional movement in respect of a standing working posture. Also provided is automatic limitation of the coordinated multifunctional movement, whose limitation is activated by the vertical height movement above a maximum height in respect of a seated working posture, so as not to alter the distance between the user's eyes and the image screen when angling the work surface with the user in a standing posture.

The multifunctional movement is coordinated with the movement of the inventive subject in a vertical direction, so as to maintain a constant distance between the shortest distance of the tabletop to the surface of the floor. A coordinated function is provided between the angling of the work surface in the horizontal plane, caused by said multifunctional movement, with movement in the vertical direction, so as to maintain a constant distance between the shortest distance of the work surface to the surface of the floor.

Also included is a horizontal tabletop which retains its position in the event of a change in the angle and height of the movable desk shelf and image screen shelf. Also included is a horizontal work surface that retains its position in the event of a change to the angle and height of the movable table surface and to the arrangement for supporting the image screen unit.

It also lies within the scope of the invention to connect the means for achieving the angular and height changes to the seat in which the user sits, so that the user is able to react immediately to his/her changed sitting position, by changing the angle of the chair backrest and/or by changing the height position of the chair cushion.

### BRIEF DESCRIPTION OF THE DRAWING

The invention will now be described in more detail with reference to exemplifying embodiments thereof and also with reference to the accompanying drawing, in which:

FIG. 1 illustrates an embodiment of the invention intended for an upright sitting posture, and shows units and distances of significance;

FIG. 2 illustrates the embodiment in an angularly changed position for a rearwardly inclined seating posture;

FIG. 3 illustrates an embodiment in a position for a standing working posture;

FIG. 4 illustrates an embodiment in an angularly changed position for a standing working posture;

FIGS. 5a-5d illustrate the function of the guide groove in respect to the relative movement of the tabletop and the image presentation screen where FIG. 5a shows an unchanged position between work surface and screen, FIG. 5b shows a first angularly changed position, FIG. 5c shows a second angularly changed position, and illustrations 4-7 in FIG. 5d shows four possible designs of the guide groove for four different patterns of movement between the angular positions of the tabletop and the screen;

FIGS. 6-9 show in simplified explanatory form the embodiment of FIG. 1 with different relative motions between the two surfaces resulting in part from unequal length links and a predetermined groove shape;

FIGS. 10-13 show similar motion points where the links are of equal lengths and the groove is the same shape as in FIGS. 6-9; and

FIGS. 14-16 illustrate an embodiment of the invention having different length links, as in FIGS. 6-9, with a different groove shape, showing how the motion points are affected.

### DETAILED DESCRIPTION OF THE PREFERRED EMBODIMENTS

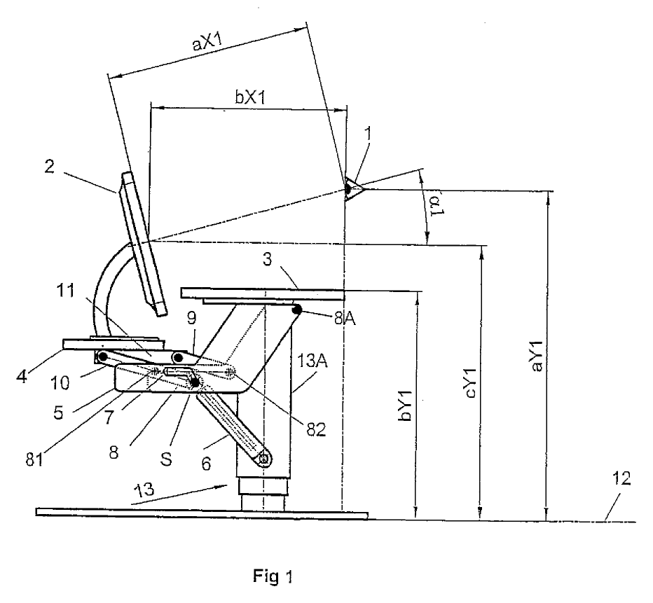

The exemplifying embodiments of the invention illustrated in FIG. 1 include a presentation device in the form of a display screen 2 in connection with a work surface in the form of a tabletop 3. The screen is releasably mounted on a supportive device in the form of a screen plate 4. All of these units can be displaced vertically at one and the same time, by virtue of being fixedly mounted on a stand 5 which, in turn, is mounted on a vertically extendable leg arrangement 13, which may be a telescopic arrangement.

To enable the screen 2 and the tabletop 3 to be positioned as desired and as necessary in relation to the user's eyes, referenced 1 in the figure, and different postures of the user's body, the stand 5 is provided with a guide groove 7 into which a stand bearing S is intended to be displaced by one end of a maneuvering device 6. The maneuvering device 6 may have the form of a pneumatic spring or of a motorized setting device whose other end is mounted on the stand 5, either directly or indirectly. In the case of the illustrated embodiment, the bearing is placed on the uppermost part 13A of the leg arrangement 13. The tabletop 3 is fastened to an angle-adjustable or pivotal frame 8 which is mounted in the stand 5 in a frame bearing SA. One end of a forwardly located link arm 9 is mounted on the pivotal frame 8, while the other end of that arm is mounted on an attachment arm 11 on which the screen plate 4 is firmly mounted. One end of a rearwardly located link arm 10 is mounted on displaceable frame or stand bearing S while the other end of arm 10 is also mounted on the attachment arm 11.

This construction of a link mechanism 6, 7, 8, 9, 10, and 11 enables the movements and degrees of freedom of the screen and the tabletop to be varied to an extent greater than the actual need, by appropriate dimensioning of the units consisting of the maneuvering device 6, the guide groove 7, the pivotal frame 8, the forwardly located link arm 9, the rearwardly located link arm 10, and the distance between the bearings in the attachment frame 11, with respect to size and placement.

The guide groove 7 is provided on the fixed stand 5, which is not angled. The maneuvering device 6 and the rearwardly located link arm 10 are fastened in the guide groove 7. The pivotal frame 8 constitutes a fourth link between a rearwardly located link bearing 81 and a forwardly located link bearing 82. This results in a four-link mechanism, which is adapted for movement by the maneuvering device 6, while the mechanism as a whole, which is supported by the fourth link, is also pivotal about the frame bearing 8A.

The following distances or spacings have been shown in FIG. 1 with the intention of further illustrating the geometries concerned: a perpendicular image screen distance aX1, a horizontal image screen distance bX1, a horizontal table height bY1, an image screen height cY1, and the height of the user's eyes aY1, all in relation to a floor surface 12. The angle defined by the image screen and the table surface has been referenced α1.

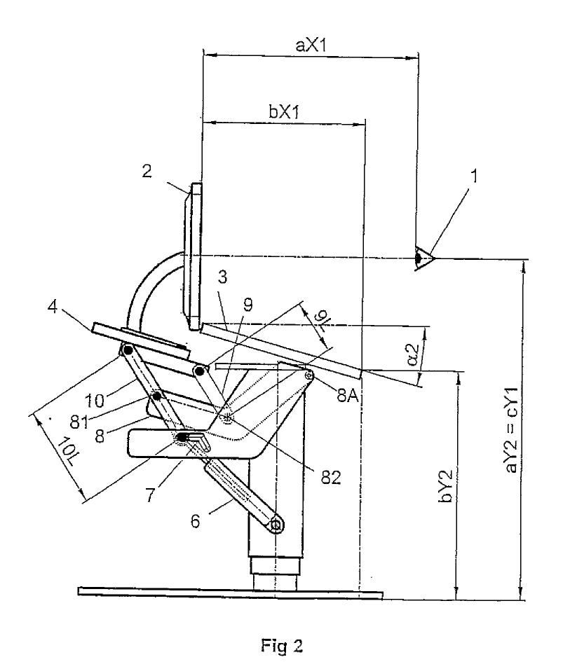

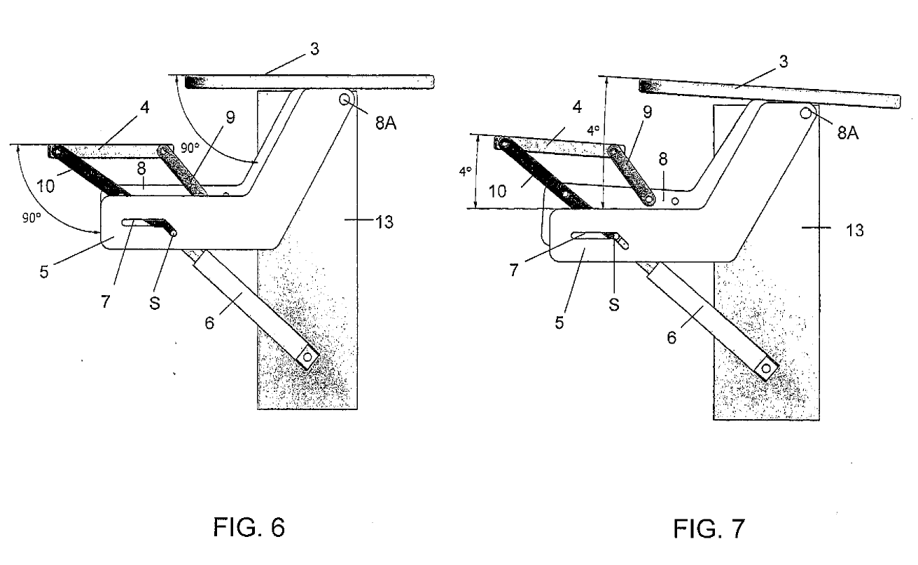

FIG. 2 shows a changed angular position, corresponding to a rearwardly inclined working posture. As is seen here, the forwardly located link arm 9 and the rearwardly located link arm 10 forms a flexible parallelogram such that the forward link arm 9 will be controlled by the rearward link arm 10. The region in which the maneuvering device 6 moves and its length of stroke, coupled with the length and design of the guide groove 7 and the lengths 9L and 10L of respective link arms and their mutual length relationships control the coordinated movement regions of the tabletop 3 and the image screen 2. The different relative angles between tabletop 3 and supporting apparatus or screen plate 4 are illustrated in FIGS. 6-16. As used herein, “flexible parallelogram” indicates parallelogram-type movement, using link arms, but it is not a true parallelogram, as is evident from the description herein.

In this case, the geometries have been changed by reducing the height of the user's eyes 1 to aY2, which corresponds to cY1 in FIG. 1, and the front edge of the table surface has been lowered to bY2. The perpendicular screen distance aX1 and the angle of the screen to the table surface α1=α2 are, however, constant.

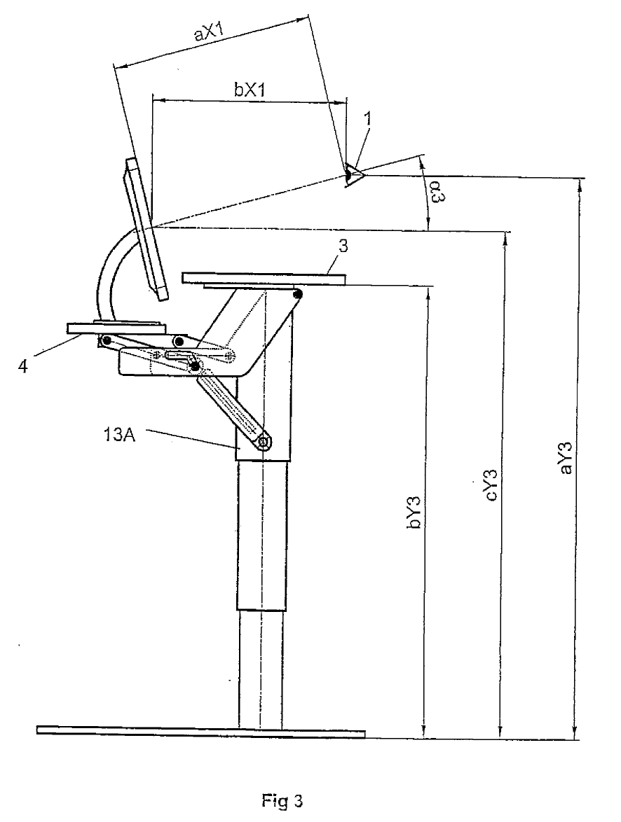

FIG. 3 illustrates the arrangement adapted for an upstanding working posture, where the geometries in respect of the perpendicular screen distance aX1 and the horizontal screen distance bX1 are the same as those shown in FIG. 1, although the distance of the horizontal table surface bY3, and the screen height cY3 and the height of the user's eyes aY3 from the surface of the floor have, of course, been increased. The angle defined by the image screen with the table surface is constant, that is, α3=α1=α2.

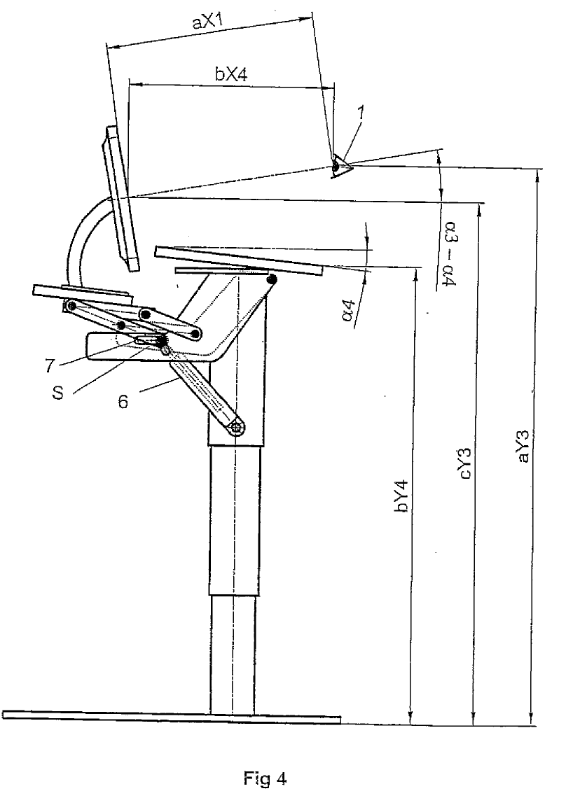

However, according to FIG. 4, an increase in the angle of the tabletop 3 and the screen plate 4 of equal magnitude is particularly beneficial, or indeed necessary, in the case of a standing working posture, where the user's eyes 1 relative to the screen 2 in the case of a desk-like angling of the tabletop 3 does not change as when a transition is made between an upright sitting posture and a rearwardly inclined posture. It is therefore appropriate to restrict angling of the tabletop 3 to the synchronized region of the screen plate 4 above the maximum height of said tabletop 3 intended for a seated working posture. This limitation may, for instance, be activated by the unit responsible for the vertical height movement 13 in the transition between a seated and a standing working posture. The geometries concerning the perpendicular screen distance aX1 and the horizontal screen distance bX1 and the screen angle to the horizontal plane are still constant, that is, α3=α1=α2. However, the tabletop is given an angle α4 to the horizontal plane, since the stand bearing S has been moved along an angled part of the guide groove 7, solely by the maneuvering device 6. The vertical distance, bY3 in FIG. 3, has herewith been reduced to bY4, while cY3 and aY3 remain constant.

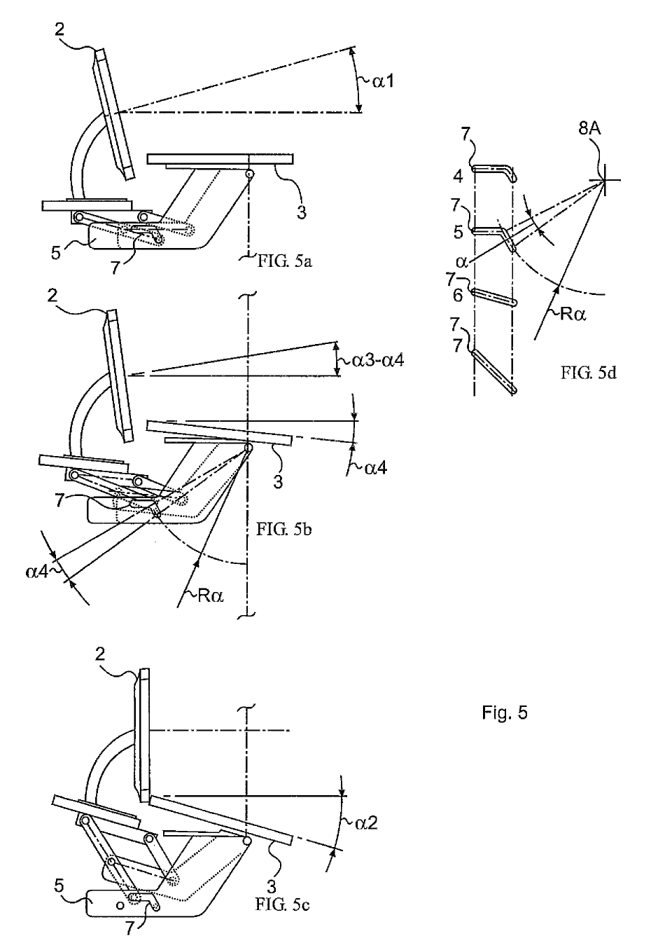

As is evident from FIG. 5, the pattern of movement of the tabletop 3 and the image screen 2 can be varied without practical limitations to construction and measurement geometry, by giving the guide groove 7 the shape and size illustrated in FIGS. 5d4, 5d5, 5d6, and 5d7. When necessary, this flexibility can be utilized by replacing the stand 5, or parts thereof, with another desirable guide groove, or by enabling the shape and length of the guide groove to be adjusted (not shown).

The design of the guide groove shown in FIG. 5d4 is identical with the design of the guide groove shown in FIGS. 5a, 5b, and 5c. The synchronized angling of the tabletop and the image screen can be increased by increasing the inclined radius-forming part of the guide groove in accordance with FIG. 5d5. The design of the guide groove 7 according to FIG. 5d6, that is, in the absence of radius-controlled movement and synchronization, provides a comparatively slow increase in the angling of the image screen in relation to the tabletop, while the design according to FIG. 5d7 provides a faster increase in the angular difference.

The distance between the front part of the tabletop and the surface of the floor 12 can be kept constant, by synchronizing vertical movement away from the floor surface 12 with the unit responsible for said vertical height movement 13A, in parallel with angling of the tabletop 3.

The angle defined by the tabletop 3 with the screen plate 4 can be increased, for example, synchronized, by forming the guide groove 7 as a radius with its origin of coordinates in the rotational center SA of the pivotal frame 8 (see FIG. 5d5). This part of the guide groove may otherwise be straight (see FIG. 5d4) instead of being radius-forming, depending on the mutual measurement conditions.

The discussion above contemplates relative movement differences between work surface or tabletop 3 and supporting apparatus or screen plate 4. FIGS. 6-16 are provided to explicitly show the flexibility available with the embodiments described above when the principles of the invention are employed.

FIG. 6 shows a starting position with tabletop 3 and screen plate 4 both at 90° with respect to the vertical. As bearing S moves up the angled leg of groove 7 pursuant to extension of maneuvering device 6, the example shown in FIG. 7 indicates that tabletop 3 and screen plate 4 remain parallel, both being tilted by 4°. Links 9 and 10, from their prospective pivot points on pivotal frame 8 and screen plate 4, are of unequal length.

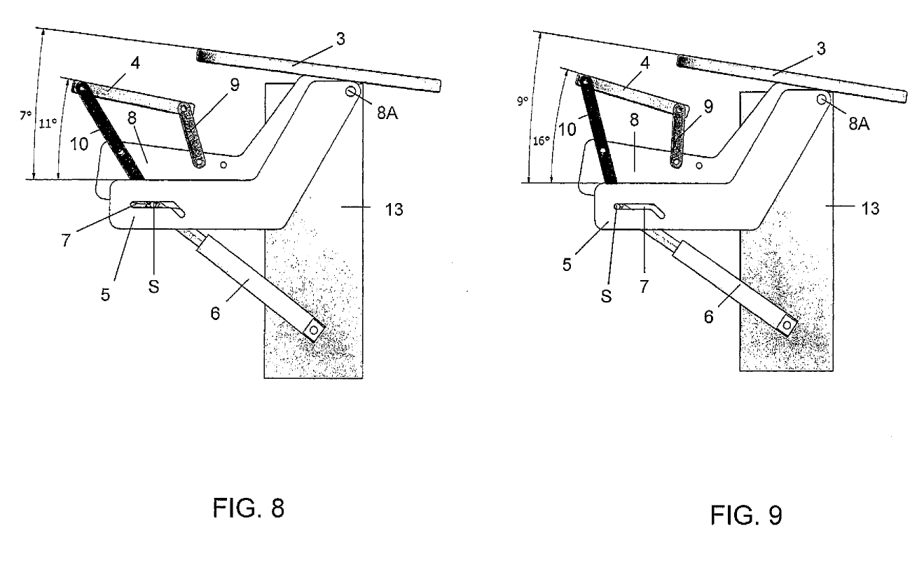

As bearing S moves into the longer portion of groove 7 in FIG. 8, the difference in length of links 9 and 10 result in an angular difference between tabletop 3 and screen plate 4, the first being shown at 7° and the latter at 11°. When bearing S moves all the way to the left end (as shown in the drawing) of groove 7, the relative angle differences become greater. Here, tabletop 3 is at 9° while screen plate 4 is at 16° (see FIG. 9).

This shows how the structure of FIGS. 1-5 can result in desired relative angle differences between screen plate 4 and consequently, display screen 2, to which the screen plate is mounted, and tabletop 3. It is a combination of the links, groove 7, and the various pivot points that facilitate these angle variations.

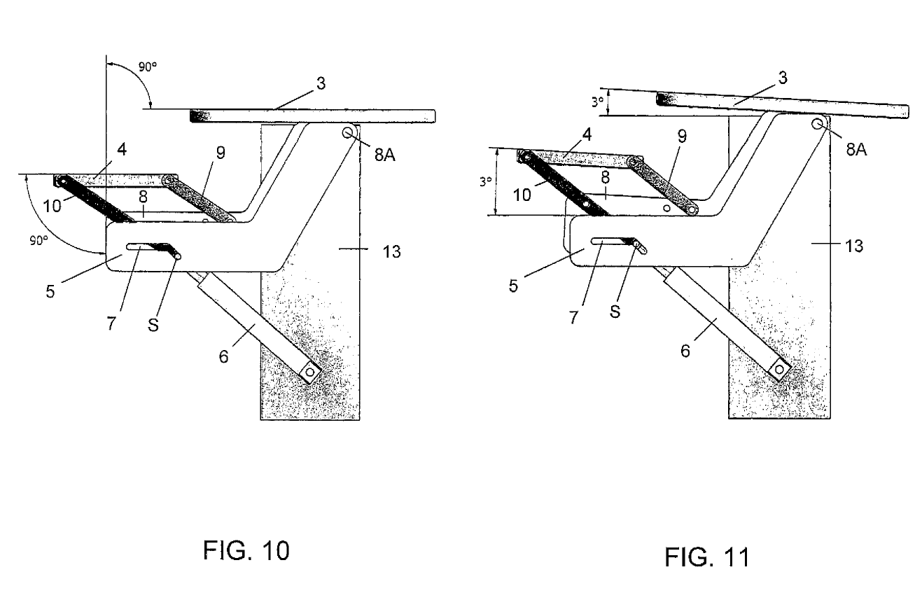

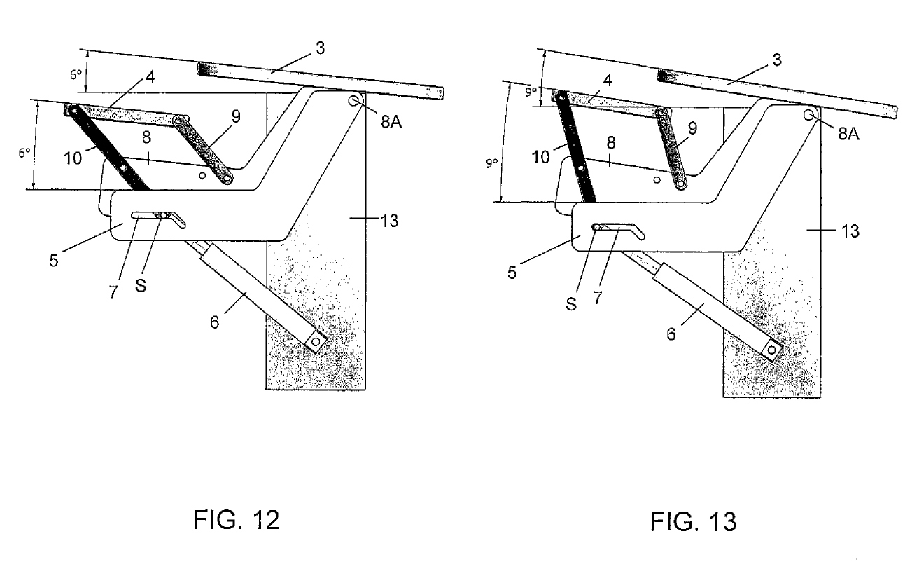

In FIGS. 10-13, groove 7 is the same as in FIGS. 6-9, but links 9 and 10 are of equal length, when considering their respective pivotal connections to screen plate 4 and pivotal frame 8. In this instance, as maneuvering device 6 moves bearing S along groove 7, tabletop 3 and screen plate 4 remain parallel. At the starting point in FIG. 10, both are at 90° with respect to the vertical. As bearing S moves up the short angled leg of groove 7, both surfaces 3 and 4 change by 3° in FIG. 11, 6° in FIG. 12, and 9° in FIG. 13.

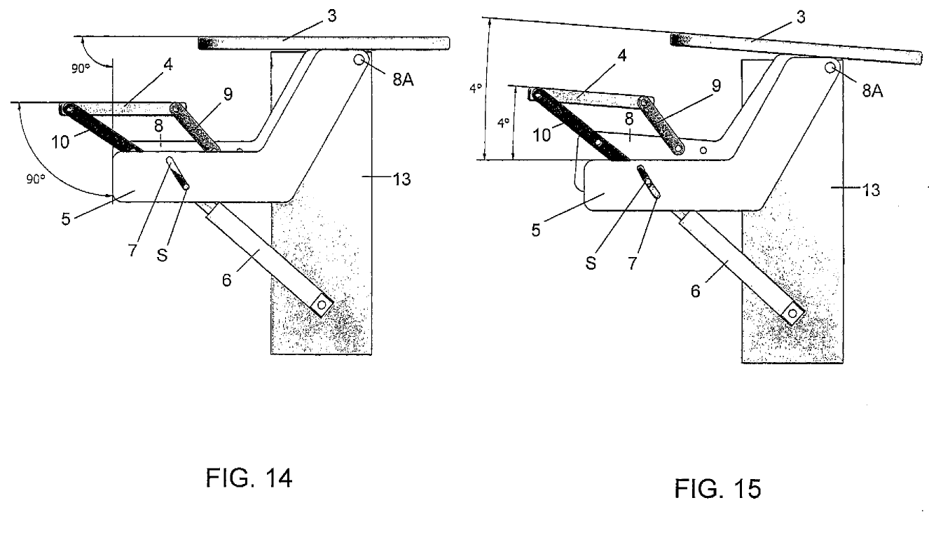

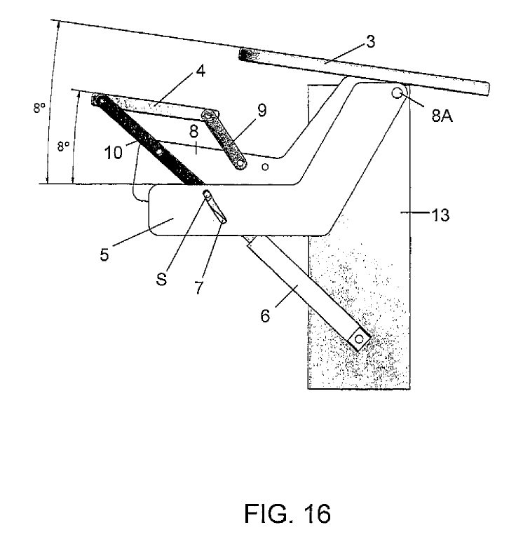

Another example is shown in FIGS. 14-16. Groove 7 is as shown in FIG. 5d7. Here, by choosing the shape and angle of groove 7, and with links 9 and 10 of different lengths functioning with this particular guide groove angle and shape, movement of maneuvering device 6 results in surfaces 3 and 4 remaining parallel. In FIG. 14, at the starting position, tabletop 3 and screen plate 4 are both at 90° with respect to the vertical. With extension of device 6, both surfaces are at 4°, as shown in FIG. 15. FIG. 16 shows both surfaces at 8° from that shown in FIG. 14.

Thus, it is clearly evident that by choosing the guide groove shape and angle, and the lengths of links 9 and 10, the relative angles of tabletop 3 and screen plate 4 can be varied to suit the situation of the user, as was explained in the Summary and in the descriptions of FIGS. 1-5.

What is claimed is:

1. A presentation device comprising:
a stand having a guide groove;
a supporting arrangement pivotably mounted to said stand;
an image screen mounted to said supporting arrangement;
a pivotally movable work surface mounted to said stand, said work surface and said supporting arrangement being vertically and transversely movable, pivotal movement of said work surface being forcibly coupled to pivotal movement of said supporting arrangement and controlled by a link mechanism, said link mechanism comprising a pivotal frame which is pivotable about a bearing in said stand, a forwardly located link arm, a rearwardly located link arm and an attachment arm, wherein said rearwardly located link arm is connected to said pivotal frame through the medium of a rearwardly located link bearing, and wherein said forwardly located link arm is connected to said pivotal frame through the medium of a forwardly located link bearing, one end of said rearwardly located link arm being provided with a stand bearing which is movable in said guide groove in said stand; and
first maneuvering means coupled to said stand so as to simultaneously change the angle of said supporting arrangement and the angle of said work surface in relation to said stand, wherein the change of said angles in relation to said stand can differ from each other, said first maneuvering means being adapted to cause displacement of said stand bearing in said guide groove.

2. The device according to claim 1, wherein at least a part of said guide groove is rectilinear.

3. The device according to claim 2, wherein said guide groove extends selectively in a horizontal direction or defines an angle with the horizontal.

4. The device according to claim 2, wherein said guide groove comprises a part which is angled in relation to said rectilinear part.

5. The device according to claim 4, wherein said angled part of said guide groove is selectively rectilinear or includes part of the arc of a circle with its radius in the bearing of said pivotal frame.

6. A presentation device comprising:
a stand having a guide groove;
supporting apparatus pivotably mounted to said stand;
an image screen mounted to said supporting apparatus;
a pivotally movable work surface mounted to said stand, said work surface and said supporting apparatus being vertically and transversely movable, pivotal movement of said work surface being forcibly coupled to pivotal movement of said supporting apparatus; and
first maneuvering means coupled to said stand so as to simultaneously change the angle of said supporting arrangement and the angle of said work surface in relation to said stand, wherein the change of said angles in relation to said stand can differ from each other.

7. The device according to claim 6, wherein the forced angular movement is controlled by a link mechanism.

8. The device according to claim 7, wherein said link mechanism includes a pivotal frame which is pivotable about a bearing in said stand, a forwardly located link arm, a rearwardly located link arm, and an attachment arm, wherein said rearwardly located link arm is connected to said pivotal frame through the medium of a rearwardly located link bearing, and wherein said forwardly located link arm is connected to said pivotal frame through the medium of a forwardly located link bearing.

9. The device according to claim 8, wherein one end of said rearwardly located link arm is provided with a stand bearing, which is movable in said guide groove in said stand.

10. The device according to claim 9, wherein said first maneuvering means is adapted to cause displacement of said stand bearing in said guide groove.

11. The device according to claim 10, wherein said first maneuvering means has the form of a pneumatic piston-cylinder device, which is connected at one end to said stand bearing and at the other end to said stand.

12. The device according to claim 6, and further comprising:
a vertically extendable leg support; and
a further maneuvering means;
wherein said supporting apparatus, said work surface, said first maneuvering means, and said stand are mounted on an upper part of said leg support.

13. The device according to claim 7, and further comprising:
a vertically extendable leg support; and
a further maneuvering means;
wherein said supporting apparatus, said work surface, said first maneuvering means, and said stand are mounted on an upper part of said leg support.

14. The device according to claim 8, and further comprising:
a vertically extendable leg support; and
a further maneuvering means;
wherein said supporting apparatus, said work surface, said first maneuvering means, and said stand are mounted on an upper part of said leg support.

15. The device according to claim 9, and further comprising:
a vertically extendable leg support; and
a further maneuvering means;
wherein said supporting apparatus, said work surface, said first maneuvering means, and said stand are mounted on an upper part of said leg support.

16. The device according to claim 10, and further comprising:
a vertically extendable leg support; and
a further maneuvering means;
wherein said supporting apparatus, said work surface, said first maneuvering means, and said stand are mounted on an upper part of said leg support.

17. The device according to claim 11, and further comprising:
a vertically extendable leg support; and
a further maneuvering means;
wherein said supporting apparatus, said work surface, said first maneuvering means, and said stand are mounted on an upper part of said leg support.

18. The device according to claim 9, wherein at least a part of said guide groove is rectilinear.

19. The device according to claim 10, wherein at least a part of said guide groove is rectilinear.

20. The device according to claim 11, wherein at least a part of said guide groove is rectilinear.

21. The device according to claim 18, wherein said guide groove extends selectively in a horizontal direction or defines an angle with the horizontal.

22. The device according to claim 18, wherein said guide groove also includes a part which is angled in relation to said rectilinear part.

23. The device according to claim 22, wherein said angled part of said guide groove is selectively rectilinear or includes part of the arc of a circle with its radius in the bearing of said pivotal frame.
